(19) United States
(12) Patent Application Publication
(10) Pub. No.: US 2008/0077439 A1
(43) Pub. Date: Mar. 27, 2008

(54) AUTOMATED MEDICATION CALENDAR

(75) Inventor: Willie K. GUION, Martinez, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: MEDICAL COLLEGE OF GEORGIA RESEARCH INSTITUTE, INC, Augusta, GA (US)

(21) Appl. No.: 11/858,547

(22) Filed: Sep. 20, 2007

Related U.S. Application Data
(60) Provisional application No. 60/846,156, filed on Sep. 21, 2006.

(51) Int. Cl. G06Q 50/00

(52) U.S. Cl. 705/2

(57) ABSTRACT

A calendar-format medication instruction sheet is produced when a pharmacy processes a patient's prescription. The sheet can bear icons or photographic images of the medications that the patient is to take, overlayed on a calendar grid to indicate the days on which the patient is to take them, and can also bear icons or photographic images indicating how the patient is to take them. The icons, photographic images, or other graphical information can be obtained from a remote server as needed.

### CROSS-REFERENCE TO RELATED APPLICATION

The benefit of the filing date of U.S. Provisional Patent Application Ser. No. 60/846,156, filed Sep. 21, 2006, is hereby claimed, and the specification thereof is incorporated herein in its entirety by this reference.

### BACKGROUND OF THE INVENTION

1. Field of the Invention

The present invention relates generally to systems and methods for processing medication prescriptions and, more specifically, to medication processing systems and methods that communicate medication instructions to patients.

2. Description of the Related Art

In filling a prescription for medications, a pharmacist typically enters the information from the prescription into a computer-based prescription system. The system aids the pharmacist in filling the prescription, i.e., dispensing the medications, and prints a label to be affixed to the medication container. The label generally includes instructions directing the patient when to take the medications and how to take the medications. For example, a patient may be directed to take a specified pill twice daily for seven days and to take the pill orally with water and a meal.

A patient's failure to take prescribed medications in the manner directed by a physician or pharmacist can jeopardize a patient's health and safety. Some medications can be harmful or at least less effective when taken in a manner contrary to that which was instructed.

Many patients find the medication instructions on the container label difficult to read or understand. A patient can especially become confused when instructed to take several different medications on different days, in different amounts (e.g., different numbers of pills), at different times of day, some with water, some with food, etc.

Medication reminder and compliance devices have been proposed that produce visual aids to promote compliance with medication instructions. For example, U.S. Patent Application Publication No. 2004/0188998 describes producing a calendar-like label that can be affixed to a medication container in place of or in addition to the standard medication instructions or used separately. The label indicates in calendar format on which day of the week and at what time to take the medication. To create the label, a pharmacist uses a computer operating under a specialized software application program. The pharmacist enters into the computer such information as the number of days the patient is to take the medication, the day of the month on which the patient is to begin taking the medication, and the number of doses per day that the patient is to take. However, pharmacists may be reluctant to adopt such a system, as they may find it cumbersome and inconvenient to use along with the pharmacy's existing computer-based prescription system.

### SUMMARY OF THE INVENTION

The present invention relates to a system, method and computer program product for producing a calendar-format medication instruction sheet. In an exemplary embodiment of the invention, the system includes a software application that interfaces with the pharmacy's existing prescription system. When the pharmacist interacts with the computer prescription system by, for example, entering the prescription information and pressing a “Fill Prescription” button on the graphical user interface screen, that same act causes the novel software application of the present invention to obtain the prescription information from the prescription system and use it to produce (e.g., to print) a calendar-format sheet to which a patient can refer to more readily understand the medication instructions. The sheet can be provided to the patient to supplement conventional materials, e.g., medication container bearing a conventional instruction label.

The prescription information, including information identifying the one or more medications that the patient is to take, and information indicating when the patient is to take each medication, is translated into graphical depictions that are overlaid on the calendar grid. Thus, a graphical depiction identifying a medication is placed within each day on the calendar on which the patient is to take that medication. Additional graphical depictions overlaid on the calendar grid in this manner can include the time of day at which the patient is take the medication and how the patient is to take the medication. The graphical depictions can include icons or, alternatively or in addition, actual photographic images. For example within the grid space representing a certain calendar day, there can be a photographic image of a pill that the patient is to take on that day, along with an icon resembling a glass of water to indicate that the patient is to take the pill with water.

The following Detailed Description illustrates the invention more fully, through one or more exemplary or illustrative embodiments of the invention. It should be noted that although the invention is described with regard to exemplary embodiments in which the patient is human, the invention similarly can be embodied for veterinary use.

### BRIEF DESCRIPTION OF THE DRAWINGS

FIG. 1 is a block diagram of a pharmacy computer prescription system in accordance with the prior art.

FIG. 2 is a block diagram of a pharmacy computer system, programmed to produce a calendar-format medication instruction sheet, in accordance with an exemplary embodiment of the present invention.

FIG. 3 depicts a first exemplary calendar-format sheet produced in accordance with the present invention.

FIG. 4 depicts a second exemplary calendar-format sheet produced in accordance with the present invention.

FIG. 5 depicts a third exemplary calendar-format sheet produced in accordance with the present invention.

FIG. 6 depicts a fourth exemplary calendar-format sheet produced in accordance with the present invention.

FIG. 7 is a flow diagram illustrating an exemplary method for producing a calendar-format medication instruction sheet, in accordance with the present invention.

### DETAILED DESCRIPTION OF AN EXEMPLARY EMBODIMENT

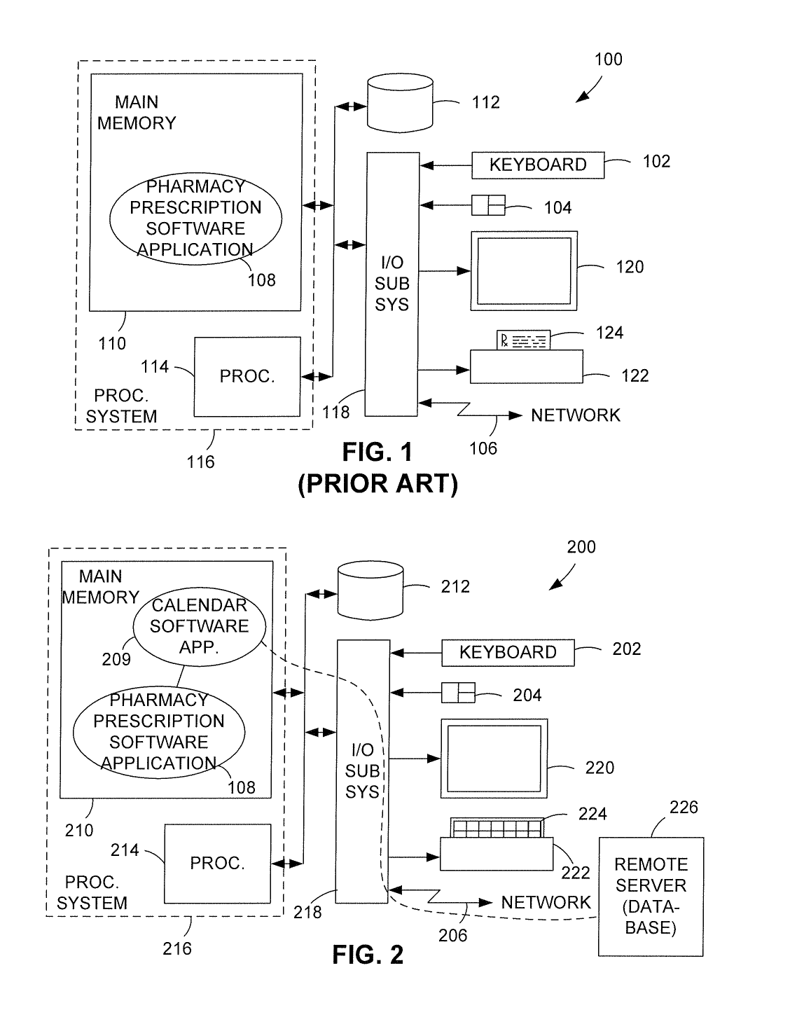

As illustrated in FIG. 1, a conventional pharmacy prescription system includes a computer system 100 that is programmed to receive prescription information that the pharmacist inputs in the conventional manner, e.g., using a keyboard 102, mouse 104, etc. Computer system 100 can include a conventional personal computer, either standing alone or operating in conjunction with a separate server computer (not shown) via a local-area network connection 106.

The software elements of such a system include a pharmacy prescription application program 108, which is conceptually shown for purposes of illustration as residing in the main memory 110 of computer system 100. (Persons skilled in the art to which the invention relates understand that, in accordance with well-understood computing principles, such software elements do not necessarily reside in their entireties in such a memory 110 but rather are retrieved from a data storage device 112 (e.g., a hard disk drive) in modules or other portions on an as-needed basis under control of the processor 114.) Processor 114, memory 110 and associated hardware and software elements (not shown for purposes of clarity) commonly included for purposes of providing the processing power in such a computer system can be considered to constitute a processing system 116. In addition to pharmacy prescription application program 108, processing system 116 is programmed or configured with other software elements of the types typically included in such a system, such as an operating system (e.g., of the MICROSOFT WINDOWS family of operating systems), but such other software elements are not shown for purposes of clarity. An input/output subsystem 118 is shown as interfacing keyboard 102, mouse 104, network connection 106, a display screen 120, and a printer 122 with processing system 116, but other such hardware and software elements are similarly not shown for purposes of clarity.

In use, the operation of processing system 116 under control of prescription application program 108 gives rise to a graphical user interface (GUI). The GUI displays a form (not shown) on display screen 120 into which the pharmacist or assistant typically enters prescription information using keyboard 102 and mouse 104, though in some cases it can be entered by scanning a barcode, with a touch-screen display (not shown), or by other means. After entering the information, the pharmacist typically uses mouse 104 to click on a “Process Prescription” button or similar GUI element to request that the system process the information. In response, the system performs processing that includes storing the information in a patient database (e.g., in data storage device 112) and printing a label 124. The pharmacist or assistant then affixes label 124 to the medication container and provides the labeled container to the patient. As described above, label 124 includes patient instructions for taking the medication. In some instances, the pharmacy also provides the patient with a separate sheet of instructions or precautions.

As illustrated in FIG. 2, a pharmacy system in accordance with an exemplary embodiment of the present invention includes a computer system 200 that is programmed not only to receive prescription information that the pharmacist enters and generate a medication container label (not shown for purposes of clarity) but also to provide a calendar-format patient instruction sheet 224. Indeed, a conventional pharmacy computer system 100 (FIG. 1) can be retrofitted to produce computer system 200 in accordance with the present invention, as described in further detail below. Like the above-described computer system 100, computer system 200 is programmed to receive prescription information that the pharmacist inputs in the conventional manner, e.g., using a keyboard 202, mouse 204, etc. Computer system 200 can similarly include a conventional personal computer, either standing alone or operating in conjunction with a separate server computer (not shown) via a local-area network connection 206. In such embodiments, the functions attributed to operation under the control of application programs 108 and 209 can be performed under the control of such software operating primarily on a remote server computer (not shown).

The software elements of this system include the above-described conventional pharmacy prescription application program 108 as well as an additional calendar sheet-producing application program 209. Although these elements are conceptually shown as residing in the main memory 210 of computer system 200 for purposes of illustration, persons skilled in the art to which the invention relates understand that, in accordance with well-understood computing principles, such software elements would not in operation necessarily reside in such a memory 20 in their entireties or simultaneously but rather would be retrieved from storage devices (e.g., a hard disk drive 212) in modules or other portions on an as-needed basis under control of the processor 214. (Note that in embodiments of the invention in which the computer that the pharmacist uses acts as a client computer, and some or all of the processing occurs on a server computer, some or all of the software elements would be associated with the server computer rather than the client computer.) Also, calendar sheet-producing application program 209 can be installed, updated and maintained remotely via network connection 206. Processor 214, memory 210 and associated hardware and software elements (not shown for purposes of clarity) commonly included for purposes of providing the processing power in such a computer system can be considered to constitute a processing system 216. It should be noted that the above-described software elements as stored or residing in memory 210, data storage device 212, or other such computer-readable medium define a “computer program product.”

In addition to pharmacy prescription application program 108 and calendar sheet-producing application program 209, processing system 216 is programmed or configured with other software elements of the types typically included in such a system, such as an operating system (e.g., of the MICROSOFT WINDOWS family of operating systems), but such other software elements are not shown for purposes of clarity. An input/output subsystem 218 is shown as interfacing keyboard 202, mouse 204, network connection 206, a display screen 220, and a printer 222 with processing system 216, but other such hardware and software elements are similarly not shown for purposes of clarity.

To use the above-described system, the operation of processing system 216 under control of prescription application program 108 gives rise to a GUI as described above with regard to the conventional system of FIG. 1. The pharmacist enters prescription information using the conventional GUI as described above. In response to entering the information and clicking on a “Process Prescription” or similar GUI element, the system not only performs processing that includes storing the information in a patient database (e.g., in storage device 212) and printing a label (not shown in FIG. 2 for purposes of clarity) in the conventional manner under control of pharmacy prescription application program 108 but also producing a calendar-format sheet 224 under control of sheet-producing application program 209.

To produce sheet 224, system 200 obtains the prescription information used by pharmacy prescription application program 108. For example, the prescription information may be transferred directly from application program 108 to application program 209. As indicated in FIG. 2, the two application programs 108 and 209 interface with one another. (Although they are shown as interfacing directly with one another in the exemplary embodiment, in other embodiments of the invention they can interface via a network connection between remote computers or in any other suitable manner.) Alternatively, the prescription information may be stored in a common database (e.g., in data storage device 212) to which both application programs 108 and 209 have access. In any event, the pharmacist or other user does not need to enter the prescription information twice using two separate application programs; rather, the information can be entered in the conventional manner in which it is entered into the conventional pharmacy prescription application program 108, and the sheet-producing application program 209 automatically obtains the information that has been entered. The prescription information is then automatically combined with graphical information in the manner described below and used to produce sheet 224, as described below.

System 200 can obtain the graphical information, as well as any other information needed to produce sheet 224 that is not available locally to computer system 200, from a remote server (hosting a database) 226 via network connection 206, as conceptually indicated in dashed line. Server 226 can be located far from system 200 and can serve multiple pharmacies and be administered under a contractual arrangement by a business entity that is separate from those that administer the pharmacies. By storing the majority of the information needed to produce sheet 224 on remote server 226, the amount of information needed to be stored on system 200 can be minimized. Also, the business entity that administers remote server 226 can bear responsibility for keeping such information current and otherwise maintaining it, relieving the pharmacies of such burdens, while maintaining the confidential patient prescription information securely within the local confines of pharmacy computer system 200.

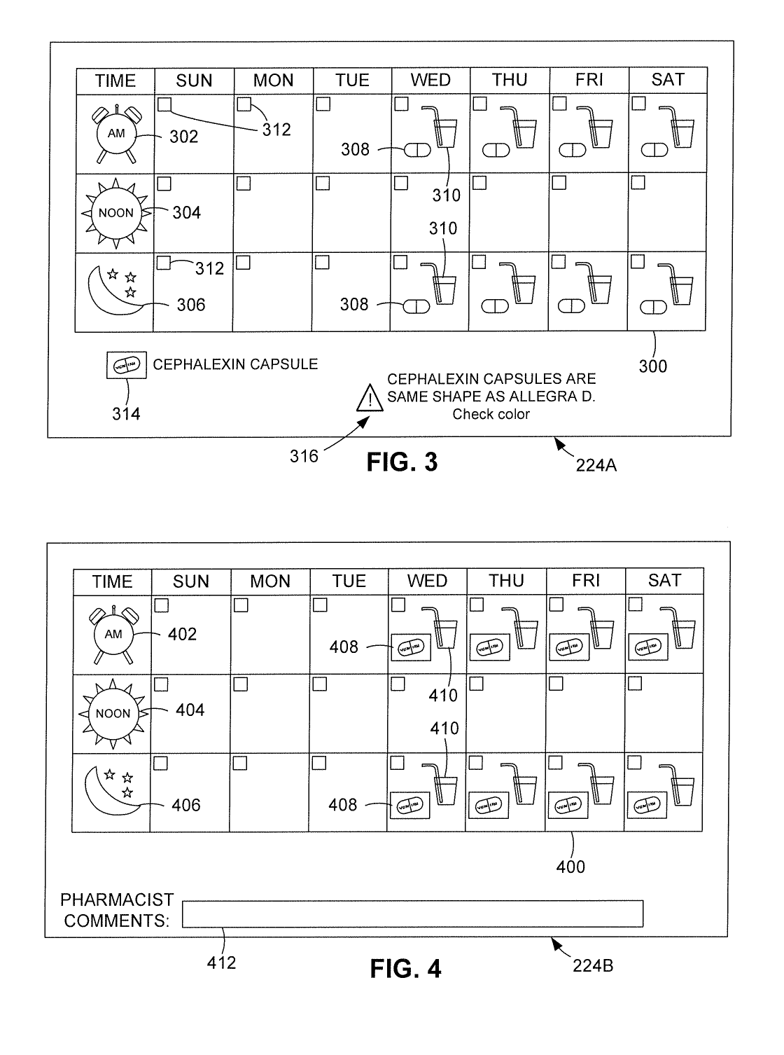

Various exemplary sheets 224 are illustrated in FIGS. 3-6. The sheet can comprise a suitable substrate, such as paper or plastic, on which is printed various graphical indicia, depicting in visual or graphical form various aspects of the medication instructions with respect to a calendar, as described in further detail below. The sheet can be of any suitable size, including a size small enough to serve as a label that can be affixed to a medication container and larger sizes (e.g., several inches per side) that can serve as charts to which a patient can refer.

A first exemplary sheet 224A is illustrated in FIG. 3. Sheet 224A bears a graphical depiction of a calendar grid 300 comprising a week of calendar days. Although in this exemplary sheet 224A, one week is depicted, other such sheets 224 can depict more days or fewer days. Also, the calendar can have any suitable configuration. Various times of day are also indicated on the calendar grid by a morning icon 302, a noon or midday icon 304, and an evening icon 306. In other embodiments of sheet 224, more or fewer times of day can be indicated. For example, the depictions can include the hours of the day instead of or in addition to such icons.

A graphical depiction representing medication is disposed within each grid space representing a calendar day on which the patient is to take that medication. For example, the graphical depiction can be a medication icon 308. Icon 308 can resemble the medication and the mode by which it is taken. For example, the icon can resemble a pill in instances in which the medication that the patient is to take is in pill form, a liquid-filled spoon or cup in instances in which the medication is in an oral liquid form, a medicine dropper in instances in which the medication is dispensed in droplets, etc. All of the information needed to determine where on the calendar grid such icons 308 are to be disposed can be obtained from the conventional prescription information, including the day on which the patient is to begin taking the medication, the number of days the patient is to take the medication, how many times per day the patient is to take the medication, etc. In this example, the prescription information calls for the patient to take the medication twice per day (“b.i.d.” in standard prescription notation). Algorithms embodied in sheet-producing application program 209 can readily determine at what times of day to indicate a medication is to be taken, based upon the number of times per day the patient is to take the medication and the number of graphical times per day indicated in the calendar graphical information. In this example, as there are three graphical times of day indicated, icon 308 for a medication that is to be taken twice per day can be disposed in the grid space corresponding to morning and the grid space corresponding to evening, as shown.

A graphical depiction of something that further describes how the patient is to take the medication can also disposed within each grid space representing a calendar day on which the patient is to take a medication. For example, such a graphical depiction can be a water icon 310, indicating that the patient is to take the medication with water. Icon 310 can resemble, for example, a glass of water with a drinking straw. Any other mode or way of taking a medication can similarly be represented by such an icon. Well-known modes include: with food; orally; sublingually; without food; without dairy products; shaken; stirred; chilled; via a medicine dropper; and hypodermically. Any such mode or way of taking a medication can be represented by a suitable icon. Examples of icons representing such additional modes or ways of taking medication are not shown, as persons skilled in the art will readily be capable of creating or obtaining suitable graphical indicia.

Each calendar grid space representing a day can also include a graphical checkbox 312 in which the patient can write an “X” or check mark to indicate that he or she took the medication that day.

In addition, sheet 224A can include a photographic image 314 of a unit of the actual medication, e.g., a photographic image of a pill, to help the patient avoid taking the wrong pill if the patient has several different types of pills. The name of the pill can also be displayed. (In the example shown in FIG. 3, “CEPHALEXIN capsule.”) Also, sheet 224A can include a suitable warning 316 if the medication resembles another medication. (In the example shown in FIG. 3, the patient is warned that “CEPHALEXIN capsules are the same shape as ALLEGRA D.” and that the patient should “check color” to ensure the color of the pill is that which is shown in photographic image 314.) Resemblance between two medications can readily be determined by analyzing each medication's National Drug Code (NDC) number. Such additional information and graphics can be obtained from remote server 226 along with the graphical information described above.

A second exemplary sheet 224B is illustrated in FIG. 4. Like the sheet described above, sheet 224B bears a graphical depiction of a calendar grid 400 comprising a week of calendar days. Various times of day are also indicated by a morning icon 402, a noon or midday icon 404, and an evening icon 406. However, instead of an icon, the image representing the medication on sheet 224B is a photographic image 408 of the medication. A water icon 410 is also included on sheet 224B as with the sheet described above. In addition, sheet 224B includes a text box 412 that reflects any comments that the pharmacist may have entered. The GUI provided by conventional pharmacy prescription application program 108 allows a pharmacist to enter comments, such as precautions or warnings. Conventionally, such comments are printed (in very small and thus difficult-to-read type font) on the label affixed to the medication container. In contrast, text box 412 conveys any such comments to the patient in a convenient and easily readable manner. It should also be noted that although a warning similar to warning 316 discussed above with regard to FIG. 3 is not shown in FIG. 4, any of the graphical depictions described herein with regard to any of sheets 224 can be included in any suitable combination with each other in any other sheet 224.

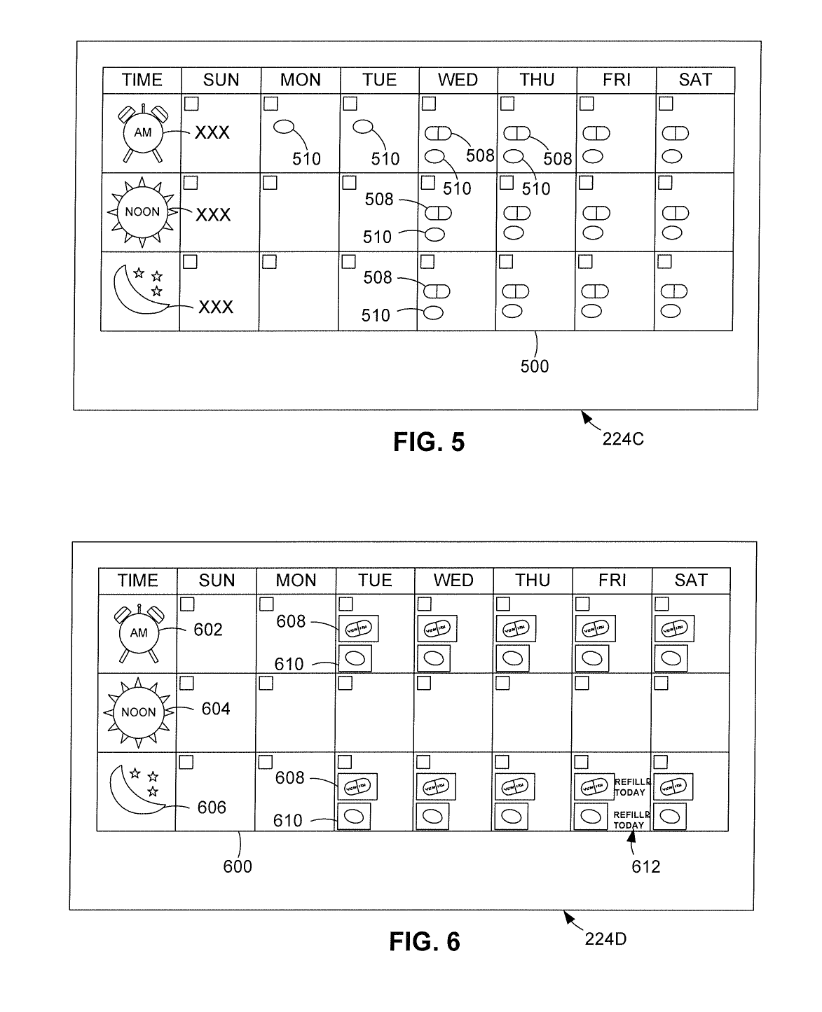

A sheet 224 can indicate to the patient to take multiple medications that have been prescribed. A third exemplary sheet 224C is illustrated in FIG. 5. Like the sheets described above, sheet 224C bears a graphical depiction of a calendar grid 500 comprising a week of calendar days. Various times of day are also indicated by a morning icon 502, a noon or midday icon 504, and an evening icon 506. Icons 508 and 510 representing two different medications are depicted to indicate to the user to take the corresponding medications.

A fourth exemplary sheet 224D is illustrated in FIG. 6. Like the sheets described above, sheet 224D bears a graphical depiction of a calendar grid 600 comprising a week of calendar days. Various times of day are also indicated by a morning icon 602, a noon or midday icon 604, and an evening icon 606. Photographic images 608 and 610 of two different medications are depicted to indicate to the user to take those medications.

In addition, sheet 224 bears refill icons 612 (“Refill Rx today”) disposed within one of the calendar days to indicate an optimal day for the patient to refill prescriptions for both medications. In an instance in which a patient has been prescribed two or more medications, depending upon when the patient is instructed to begin taking each medication and how many times per day the patient is instructed to take each medication, and how many units (e.g., pills) of each medication the patient is to take at a time, the patient may deplete his or her supply of one medication before depleting the supply of another medication. If the patient were to refill the prescription for each medication as it was depleted, the patient might need to make multiple trips to the pharmacy. To minimize the number of trips, the present invention can compute an optimal day to refill two or more prescriptions at the same time. For example, it may be optimal for the patient to refill both medications when the patient has only a one-day supply of a first medication left but still has a two or three-day supply of a second medication left.

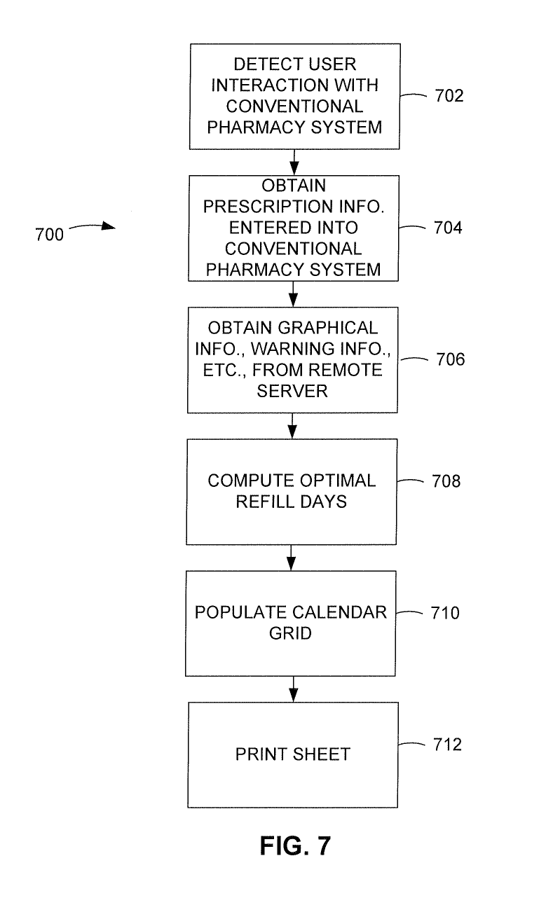

The flow diagram 700 of FIG. 7 illustrates an exemplary method of operation that can produce the above-described sheets 224. The method is effected by the operation of the programmed processing system 216 (FIG. 2). At step 702, processing system 216 detects user interaction with the conventional pharmacy prescription system, such as the user clicking on a “Process Prescription” button, as described above. Calendar sheet-producing application program 209 can detect such an event because it interfaces with conventional pharmacy prescription application program 108. At step 704, processing system 216 obtains or accesses the same prescription information that is conventionally accessible at this time through the conventional prescription system. At step 706, processing system 216 obtains from remote server 226 graphical information, drug warning information, and any other information it may need that is not available on system 200. As described above, the graphical information includes the calendar grid, images such as icons and photographic images, and any other information needed to graphically depict the items described above.

At step 708, processing system 216 computes one or more optimal prescription refill days as described above, and at step 710 computes where on the calendar to place the various graphical depictions representing what medications the patient is to take and on what days and at what times of day the patient is to take each medication. At step 712, processing system 216 causes printer 222 to print sheet 224 bearing graphical depictions as described above.

It will be apparent to those skilled in the art that various modifications and variations can be made to this invention without departing from the spirit or scope of the invention. It is intended that the present invention cover such modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A computer-implemented method for producing a calendar-format medication instruction sheet, comprising:
detecting user interaction with a pharmacy computer prescription system;
in response to a calendar sheet-producing system detecting user interaction with the pharmacy computer prescription system, the calendar sheet-producing system receiving prescription information from the pharmacy computer prescription system, the prescription information including information identifying one or more medications for a patient to take and when the patient is to take each medication; and
in response to the calendar sheet-producing system detecting user interaction with the pharmacy computer prescription system, the calendar sheet-producing system producing a sheet in response to the prescription information and in response to graphical information, the sheet bearing a graphical depiction of a calendar grid comprising a plurality of calendar days and a graphical depiction within each of a plurality of the calendar days indicating on which of the calendar days to take each medication and when during each of the calendar days to take each medication.

2. The method claimed in claim 1, wherein the sheet bears a photographic image of each medication.

3. The method claimed in claim 1, wherein the sheet bears a warning indication if any of the one or more medications resembles another medication in color and shape.

4. The method claimed in claim 1, wherein the graphical depiction within each of the plurality of the calendar days comprises an image resembling the medication, and the image resembling the medication is selected from the group consisting of: a medication icon; and a photographic image of the medication.

5. The method claimed in claim 1, wherein the sheet bears a graphical depiction within at least one of the plurality of the calendar days indicating how to take the medication.

6. The method claimed in claim 5, wherein the graphical depiction indicating how to take the medication is selected from the group consisting of an icon indicating to take the medication: with water; with food; orally; sublingually; without food; without dairy products; shaken; stirred; chilled; via a medicine dropper; hypodermically.

7. The method claimed in claim 1, wherein the sheet further bears a graphical depiction within at least one of the plurality of the calendar days indicating to refill a prescription.

8. The method claimed in claim 7, wherein:
the prescription information includes information identifying a plurality of medications for the patient to take; and
the step of the calendar sheet-producing system producing a sheet further comprises computing an optimal day to simultaneously refill prescriptions for a plurality of medications, and the sheet bears a graphical depiction within one of the plurality of the calendar days indicating an optimal refill day.

9. A system for producing a calendar-format medication instruction sheet, comprising:
a remote computer system having stored therein graphical depiction information; and
a pharmacy computer system in communication with the remote computer system via a network, the pharmacy computer system having a processing system programmed with a prescription system to receive prescription information from a user and process prescriptions and programmed with a calendar sheet-producing system to detect user interaction with the prescription system and in response:
receive the prescription information, the prescription information including information identifying one or more medications for a patient to take and when the patient is to take each medication;
receive graphical depiction information from the remote computer system; and
produce a sheet in response to the prescription information and graphical depiction information, the sheet bearing a graphical depiction of a calendar grid comprising a plurality of calendar days and a graphical depiction within each of a plurality of the calendar days indicating on which of the calendar days to take each medication and when during each of the calendar days to take each medication.

10. A computer program product for producing a calendar-format medication instruction sheet, the computer program product comprising a computer-readable medium having stored thereon instructions for, when performed by a computer system, causing the computer system to:
detect user interaction with a pharmacy computer prescription system;
receive prescription information from the pharmacy computer prescription system in response to detecting user interaction with the pharmacy computer prescription system, the prescription information including information identifying one or more medications for a patient to take and when the patient is to take each medication; and
produce a sheet in response to the prescription information and in response to graphical information, the sheet bearing a graphical depiction of a calendar grid comprising a plurality of calendar days and a graphical depiction within each of a plurality of the calendar days indicating on which of the calendar days to take each medication and when during each of the calendar days to take each medication.

11. The computer program product claimed in claim 10, wherein the sheet bears a photographic image of each medication.

12. The method claimed in claim 10, wherein the sheet bears a warning indication if any of the one or more medications resembles another medication in color and shape.

13. The computer program product claimed in claim 10, wherein the graphical depiction within each of the plurality of the calendar days comprises an image resembling the medication, and the image resembling the medication is selected from the group consisting of: a medication icon; and a photographic image of the medication.

14. The computer program product claimed in claim 10, wherein the sheet bears a graphical depiction within at least one of the plurality of the calendar days indicating how to take the medication.

15. The computer program product claimed in claim 14, wherein the graphical depiction indicating how to take the medication is selected from the group consisting of an icon indicating to take the medication: with water; with food; orally; sublingually; without food; without dairy products; shaken; stirred; chilled; via a medicine dropper; hypodermically.

16. The computer program product claimed in claim 10, wherein the sheet further bears a graphical depiction within at least one of the plurality of the calendar days indicating to refill a prescription.

17. The computer program product claimed in claim 16, wherein:
the prescription information includes information identifying a plurality of medications for the patient to take; and
the calendar sheet-producing system further computes an optimal day to simultaneously refill prescriptions for a plurality of medications, and the sheet bears a graphical depiction within one of the plurality of the calendar days indicating an optimal day.
